(19) United States
(12) Patent Application Publication
(10) Pub. No.: US 2016/0277218 A1
(43) Pub. Date: Sep. 22, 2016

(54) Facilitating Blind Detection of Pilot Sequences in a Wireless Communication Network

(71) Applicant: TELEFONAKTIEBOLAGET L M ERICSSON (PUBL), Stockholm (SE)

(72) Inventors: George Jöngren, Sundbyberg (SE); Lars Lindbom, Karlstad (SE); Fredrik Nordström, Lund (SE); Stefania Sesia, Roquefort les Pins (FR)

(21) Appl. No.: 14/411,122

(22) PCT Filed: Nov. 7, 2014
(86) PCT No.: PCT/SE2014/051324

§ 371 Date: Dec. 24, 2014

Related U.S. Application Data
(60) Provisional application No. 61/901,859, filed on Nov. 8, 2013.

(51) Int. Cl. H04L 25/02; H04W 48/16; H04L 25/08; H04L 27/26; H04L 5/00

(52) U.S. Cl. CPC H04L 25/023; H04L 25/0238; H04L 27/2649; H04L 5/0048; H04L 25/085; H04W 48/16; H04W 84/045

(57) ABSTRACT

In one aspect, a network node facilitates pilot sequence detection by a wireless device operating in a wireless communication network. The network node determines restriction information that indicates a reduction of a search space used by the wireless device for blind detection of pilot sequences from one or more interfering transmission points. Assistance data that includes the restriction information is generated. The assistance data is transmitted to the wireless device to reduce the search space used by the wireless device for the blind detection of pilot sequences according to the restriction information.

### TECHNICAL FIELD

The present invention generally relates to wireless communications, and particularly relates to facilitating blind detection of pilot sequences in a wireless communication network.

### BACKGROUND

In order to meet high capacity demands and enhance user experiences, wireless communication networks such as LTE need to be deployed with an increasing density of base stations. This densification can be achieved by cell splitting macro cells and deploying small cells in highly loaded geographical areas, or so called traffic hotspots, within the coverage area of macro cells. With densification of cellular networks, radio resources can be further reused and users will be closer to the serving base station, enabling higher bitrates.

A consequence of network densification is that wireless devices, such as user equipments or UEs, will experience lower geometries, implying that downlink inter-cell interference can be more pronounced and limit the achievable bit rates. Hence, in dense cellular deployments, interference mitigation techniques have the potential to substantially improve the performance of user devices.

To mitigate signal interference caused by nearby transmission points, it can be important for a UE to know the characteristics of the radio channels traversed by signals from the interfering transmission points. Channel information for these propagation channels can be obtained by using known signals for reference, timing or control, e.g., pilot signals. A pilot signal can include or be formed from a pilot sequence, which is a sequence of symbols used for modulation and/or demodulation. However, pilot sequences for interfering transmission points may not be known to the UE, which means that some pilot sequences must be estimated by the UE through blind detection. Blind detection thus involves detecting the pilot sequences without knowing the pilot sequences or reference symbols beforehand. The pilot sequences are searched in what may be considered a “search space,” which includes all the possible pilot sequences to search.

It is recognized herein that some pilot sequences from interfering transmission points are difficult to blindly detect because they are UE specific and/or are signaled per subframe. For example, demodulation requires estimation of the radio channel, which is done by using transmitted reference symbols or RS known by the receiver. In LTE, cell specific reference symbols or CRS are transmitted in all downlink subframes and used for mobility measurements performed by the UEs, but LTE supports UE specific RS, i.e., demodulation reference signals or DMRS. Data transmission based on transmission modes 8, 9 and 10 in LTE uses DMRS as a pilot/reference signal. A DMRS is based on a pseudo-random sequence generated by a pseudo-random sequence generator.

To blindly detect the DMRS sequences of interfering signals, a UE has to try 504*2+1 different DMRS sequences to find the correct sequence in one subframe and for one scheduled user. It is recognized herein that the sheer size of this search space imposes significant computational power requirements on the UE implementation. Further, the large number of possibilities increases the chance that the UE will incorrectly detect the DMRS sequence.

### SUMMARY

Embodiments set forth in the present disclosure describe methods and apparatuses for facilitating pilot sequence detection by a wireless device operating in a wireless communication network.

According to some embodiments, a method for facilitating pilot sequence detection by a wireless device operating in a wireless communication network includes determining restriction information that indicates a reduction of a search space used by the wireless device for blind detection of pilot sequences from one or more interfering transmission points. The method also includes generating assistance data that includes the restriction information and transmitting the assistance data to the wireless device. The restriction information may include DMRS identifier information to be used by the wireless device to determine a DMRS sequence. The restriction information may also include configurable cell ID, CCID, information that restricts a number of CCIDs to be considered by the wireless device in its blind detection operations.

According to some embodiments, a method, by a wireless device, of facilitating pilot sequence detection for operating in a wireless communication network includes receiving assistance data comprising restriction information that indicates a reduction of a search space used by the wireless device for blind detection of pilot sequences from one or more interfering transmission points. The method also includes recovering the restriction information from the assistance data and determining the reduced search space to be used by the wireless device for the blind detection of pilot sequences according to the recovered restriction information.

According to some embodiments, a network node configured to facilitate pilot sequence detection by a wireless device operating in a wireless communication network includes a processing circuit configured to determine restriction information that indicates a reduction of a search space used by the wireless device for blind detection of pilot sequences from one or more interfering transmission points. The processing circuit is also configured to generate assistance data that includes the restriction information and transmit the assistance data to the wireless device.

According to some embodiments, a wireless device configured to facilitate pilot sequence detection for operating in a wireless communication network includes a transceiver configured to transmit and receive wireless signals and a processing circuit operatively connected to the transceiver. The processing circuit is configured to receive assistance data comprising restriction information that indicates a reduction of a search space used by the wireless device for blind detection of pilot sequences from one or more interfering transmission points. The processing circuit is also configured to recover the restriction information from the assistance data and determine the reduced search space to be used by the wireless device for the blind detection of pilot sequences according to the recovered restriction information.

According to some embodiments, a non-transitory computer readable storage medium storing a computer program comprising program instructions which, when executed on at least one processing circuit of a network node, configure the network node to facilitate pilot sequence detection by a wireless device operating in a wireless communication network. This is based on causing the at least one processing circuit to perform operations to control the network node to determine restriction information that indicates a reduction of a search space used by the wireless device for blind detection of pilot sequences from one or more interfering transmission points, generate assistance data that includes the restriction information and transmit the assistance data to the wireless device.

According to some embodiments, a non-transitory computer readable storage medium stores a computer program comprising program instructions that, when executed on at least one processing circuit of a wireless device, configure the wireless device to facilitate pilot sequence detection for operating in a wireless communication network. More particularly, the program instructions cause the at least one processing circuit to perform operations to control the wireless device to receive assistance data comprising restriction information that indicates a reduction of a search space used by the wireless device for blind detection of pilot sequences from one or more interfering transmission points, recover the restriction information from the assistance data and determine the reduced search space to be used by the wireless device for the blind detection of pilot sequences according to the recovered restriction information.

According to some embodiments, a network node configured to facilitate pilot sequence detection by a wireless device operating in a wireless communication network includes a determining module configured to determine restriction information that indicates a reduction of a search space used by the wireless device for blind detection of pilot sequences from one or more interfering transmission points. The network node also includes a generating module configured to generate assistance data that includes the restriction information and a transmitting module configured to transmit the assistance data to the wireless device.

According to some embodiments, a wireless device configured to facilitate pilot sequence detection for operating in a wireless communication network includes a receiving module configured to receive assistance data comprising restriction information that indicates a reduction of a search space used by the wireless device for blind detection of pilot sequences from one or more interfering transmission points. The wireless device also includes a recovering module configured to recover the restriction information from the assistance data and a determining module configured to determine the reduced search space to be used by the wireless device for the blind detection of pilot sequences according to the recovered restriction information.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a network node configured to facilitate pilot sequence detection by a wireless device operating in a wireless communication network, according to some embodiments.

FIG. 2 is a more detailed block diagram of the network node configured to facilitate pilot sequence detection by the wireless device operating in the wireless communication network, according to some embodiments.

FIG. 3 is a diagram illustrating an example wireless communication network in which network nodes and wireless devices may operate according to embodiments described herein.

FIG. 4 is a flowchart of a method, by a network node, of facilitating pilot sequence detection by a wireless device operating in the wireless communication network, according to some embodiments.

FIG. 5 is a flowchart of a method, by a wireless device, of facilitating pilot sequence detection for operating in the wireless communication network, according to some embodiments.

FIG. 6 is a block diagram of a network node configured to facilitate pilot sequence detection by a wireless device operating in the wireless communication network, according to some embodiments.

FIG. 7 is a block diagram of a wireless device configured to facilitate pilot sequence detection for operating in the wireless communication network, according to some embodiments.

### DETAILED DESCRIPTION

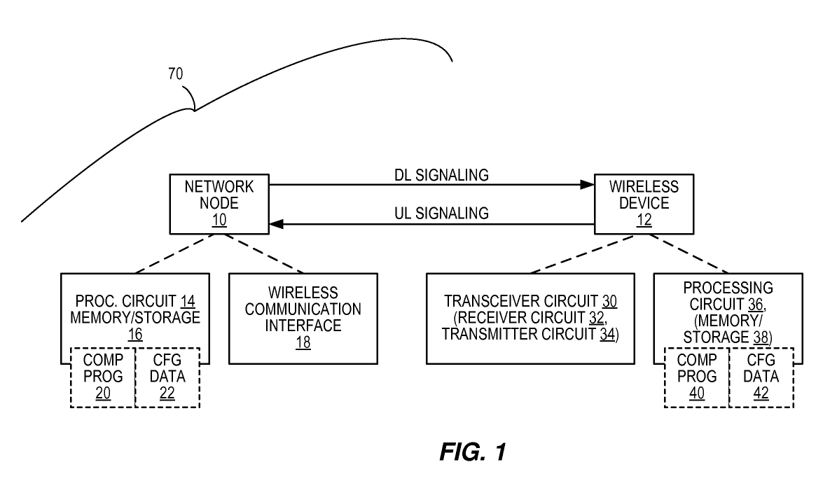

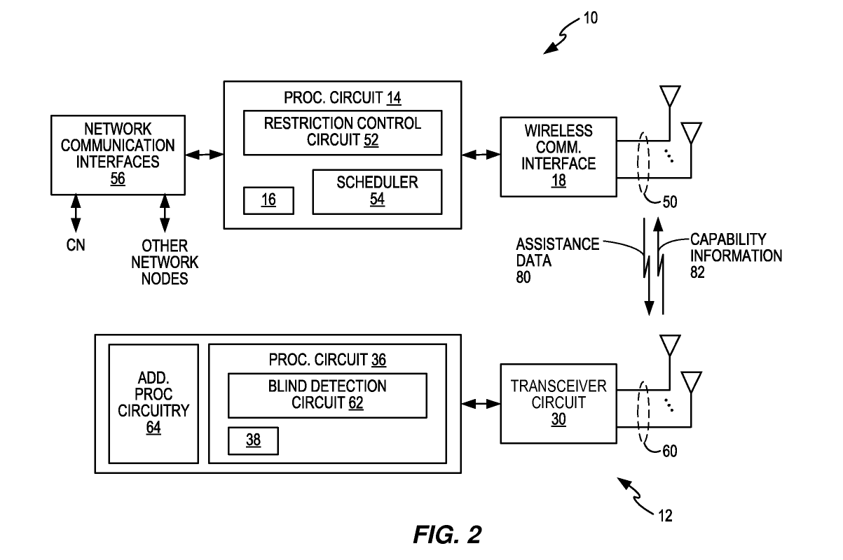

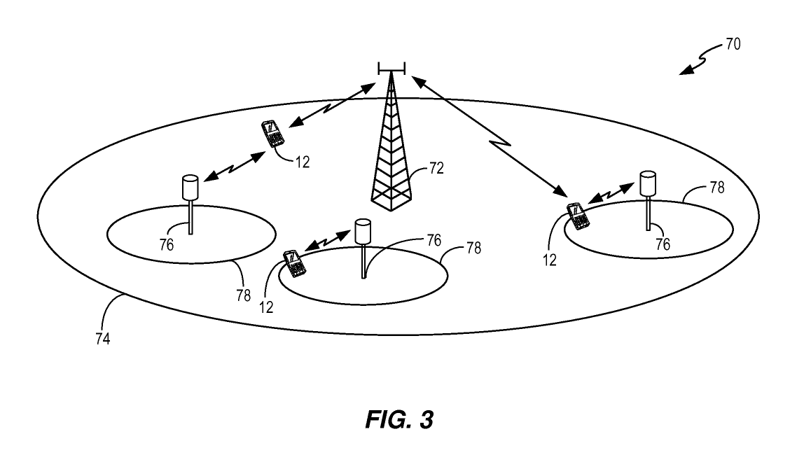

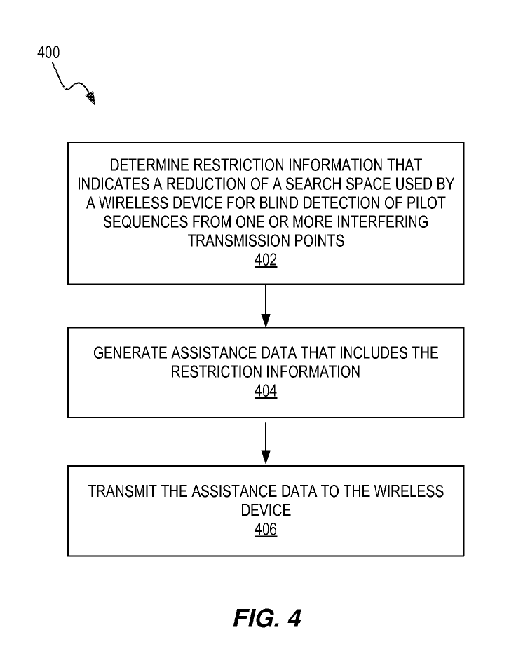

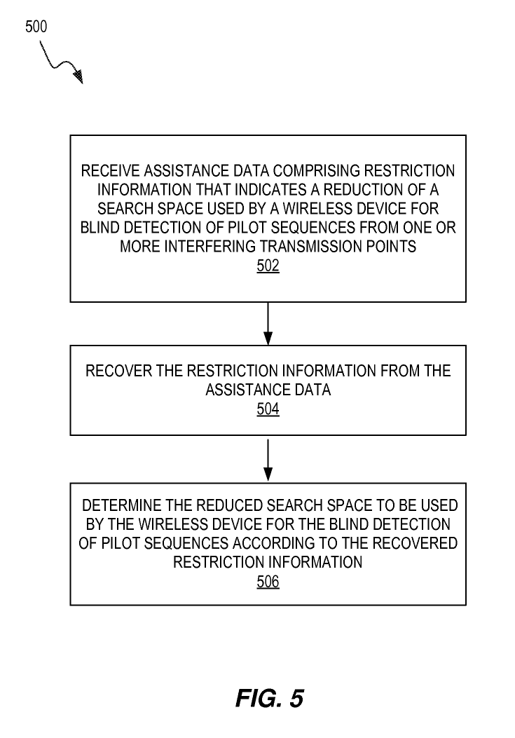

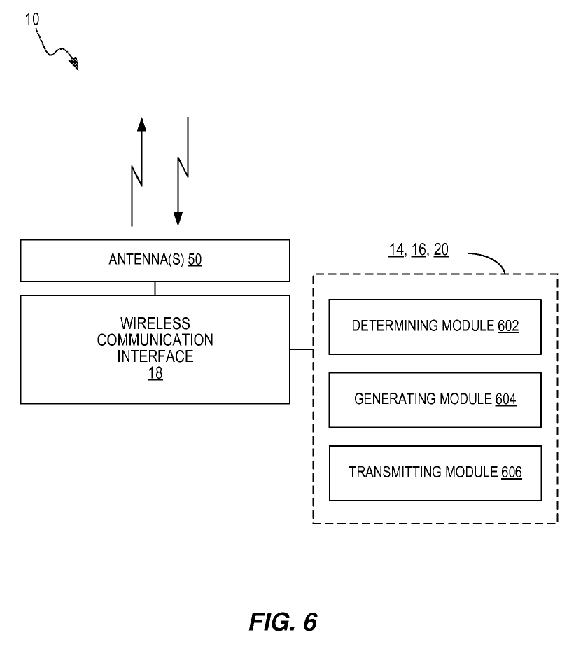

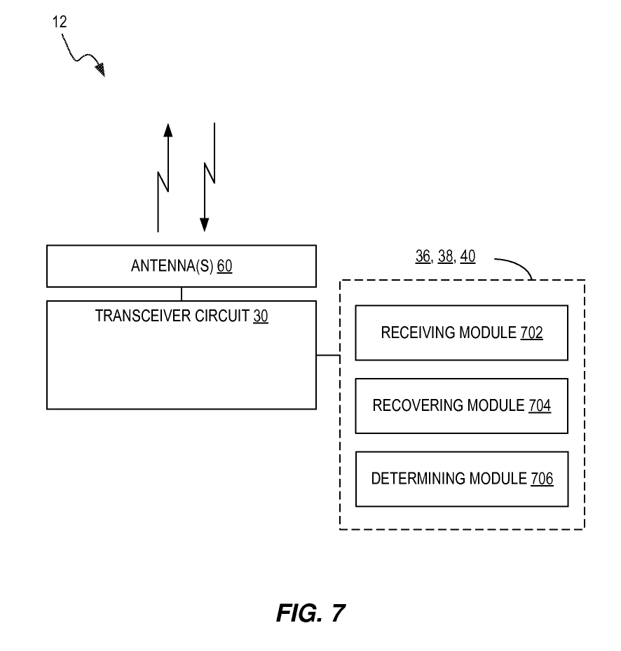

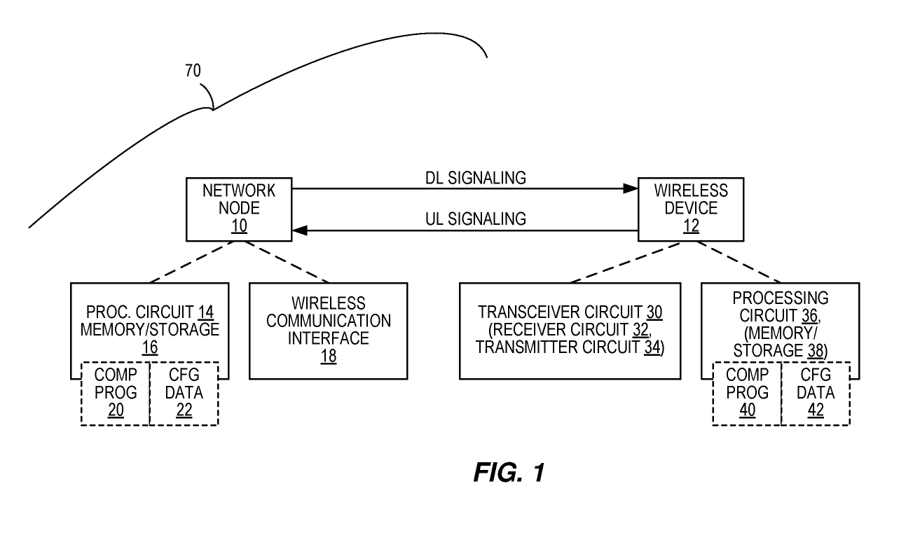

FIG. 1 illustrates a network node 10 in a wireless communication network 70, or “network 70” hereafter, that is configured according to network-side teachings herein to facilitate pilot sequence detection by a wireless device 12. The wireless device 12, such as a UE or other type of wireless apparatus, is configured to facilitate pilot sequence detection in the wireless communication network according to device-side teachings herein.

The network node 10 may comprise a base station, an eNodeB or other radio network node. The network node 10 comprises a processing circuit 14, memory/storage 16 and a wireless communication interface 18. The memory/storage 16 may comprise a mix of working memory and non-volatile program memory, such as FLASH or a Solid-State-Disk, SSD, or any other type of computer readable medium configured to provide persistent storage for, e.g., a computer program 20 and/or various configuration data 22.

The wireless communication interface 18 comprises cellular radio transceiver circuitry configured for sending signals to any number of wireless devices 12 and receiving signals from such wireless devices 12. The processing circuit 14 comprises one or more microprocessor-based circuits and/or circuitry based on one or more DSPs, ASICs, FPGAs, or other such digital processing circuit. In general, the processing circuit 14 comprises fixed circuitry or programmed circuitry, or a mix of both. For example, the processing circuit 14 is configured to perform operations according to embodiments described herein, based on the execution of computer program instructions comprising the computer program 20, as stored in the memory/storage 16, or as stored in some other computer-readable medium accessible to the processing circuit 14. The wireless device 12 may comprise a 3GPP UE or wireless communication apparatus configured for operation in the type of network in which the network node 10 is configured for operation. The wireless device 12 comprises a transceiver circuit 30 (e.g., including a receiver circuit 32 and a transmitter circuit 34), a processing circuit 36 and memory/storage 38, which may comprise a mix of working memory and non-volatile program memory, such as FLASH, or any other type of computer readable medium configured to provide persistent storage for, e.g., a computer program 40 and/or various configuration data 42.

The transceiver circuit 30 comprises a cellular radio transceiver configured for sending signals to, e.g., a network node 10 in the network 70, and receiving signals from such nodes. The processing circuit 36 comprises one or more microprocessor-based circuits and/or circuitry based on one or more DSPs, ASICs, FPGAs, or other such digital processing circuit. In general, the processing circuit 36 comprises fixed circuitry or programmed circuitry, or a mix of both. For example, in one or more embodiments, the processing circuit 36 is configured, according to embodiments described herein, based on the execution of computer program instructions comprising the computer program 40, as stored in the memory/storage 38, or as stored in some other computer-readable medium accessible to the processing circuit 36.

In an example, a method of facilitating interference mitigation includes providing and using assistance information for DMRS detection. This includes recognizing that a network assisted interference coordination capable wireless device 12, such as a UE, has connected to the network 70. The network 70 analyzes the interference conditions for the UE by using different reports from the UE and internal knowledge about current interference scenario for the UE. Reports from the UE can for example be channel quality indicator/channel state information or CQI/CSI for serving cell, CQI/CSI derived from channel state information reference symbol or CSI-RS from multiple transmission points, reference signal received power or RSRP, received signal strength indicator or RSSI, and reference signal received quality or RSRQ from serving and neighboring cells. Uplink measurements can also be employed, including measurements based on sounding reference signals or SRS, physical uplink control channel or PUCCH, physical uplink shared channel or PUSCH, and/or random access channel or RACH transmissions.

The network 70 knows a set of DMRS sequence parameters that will be used by one or more interfering transmission points. The network 70 decides it is preferable that the UE can perform good interference mitigation, or alternatively that the UE should be signaled DMRS sequence information. Next, it examines which restrictions that can be applied for the DMRS sequences for potentially interfering transmissions that may affect the UE. Potentially interfering transmissions may come from neighboring (logical) cells or may come from within the same cell as the one associated to the UE of interest. In the latter case, the interfering signal(s) may have been transmitted from neighboring point(s), the same point(s) or a combination thereof as the signals transmitted to the UE of interest. Neighboring cells can be determined from the cell list that the UE signals.

Alternatively, or in combination with the preceding paragraph, the network analyzes the DMRS sequences of transmission that may potentially interfere with a UE of interest and then signals the UE DMRS sequence information that helps the UE in finding the actually used DMRS sequences of relevant interferers. Such help may come in the form of reducing the number of candidate DMRS sequences that the UE needs to care for, or even explicitly signaling information that the UE can use to determine the DMRS sequences (or at least parts of sequences) of interferers. In many cases, the network analysis of DMRS sequences can be accomplished by exploiting that the network knows DMRS sequence parameters for many UEs and also the channel strength to different potential interfering points (via e.g. RSRP reports). Thus, the network can get a rather good picture of potential interfering transmissions and their DMRS sequence parameters.

In addition, it might be that the assignment of DMRS sequence parameters, for example CCIDs, has been planned in the network so that transmissions from the same point get the same CCID (or two CCIDs in case of utilizing CCID selector). Such an association of CCID to points (essentially point specific CCIDs as opposed to UE specific CCIDs) greatly reduces the number of different DMRS sequences a particular UE may encounter, facilitating the signaling of the remaining candidate DMRS sequence information.

The network 70 signals the DMRS sequence information to the UE. Often, the network has applied (or will apply or is planning to apply) the corresponding DMRS sequence settings in the surrounding cells/points (including its own cell/point). In parallel, the network 70 applies the DMRS sequence parameters for neighboring or interfering transmission points via coordination. The DMRS sequence parameters may also be used at the serving transmission point.

According to various embodiments, the network 70 can use any combination of the signaling alternatives described herein for signaling restriction information to the UEs. DMRS sequence signaling can be sent as a higher layer message, e.g., using radio resource control, RRC, a medium access control or MAC element, or a physical layer message that can be updated dynamically. The UEs can decode the messages containing DMRS sequence information and exploit that information for obtaining/determining a candidate set of DMRS sequences corresponding to interference signals.

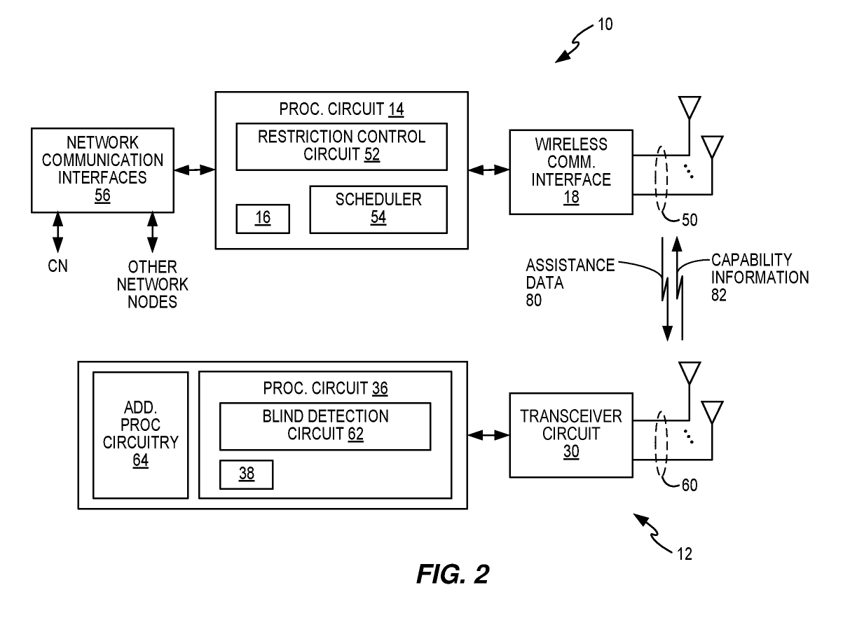

FIG. 2 illustrates further details according to non-limiting embodiments of the network node 10 and the wireless device 12. One sees for the network node 10 that the processing circuit 14 physically or at least functionally includes a restriction control circuit 52, and may further include a scheduler 54, e.g., configured for downlink and/or uplink user scheduling. The network node 10 further includes one more network communication interfaces 56 that communicatively link the network node 10, e.g., to a core network, such as to a Mobility Management Entity, and/or to other radio nodes, (e.g., base stations or, more generally, transmission points) in the network 70.

The restriction control circuit 52 is configured to carry out at least some of the network-side operations taught herein. For example, the restriction control circuit 52 is configured to identify wireless devices 12 to consider for assistance data 80, e.g., based on receiving capability information 82 from those devices 12. The capability information 82 indicates capabilities of the wireless device 12. These capabilities may include interference mitigation capabilities, such as the capability of reducing a pilot sequence search space based on recovered restriction information from assistance data 80. The assistance data 80 contains information to assist the wireless device 12 in interference mitigation, including restriction information that indicates a reduction of the search space used by the wireless device 12 for blind detection of pilot sequences from one or more interfering transmission points.

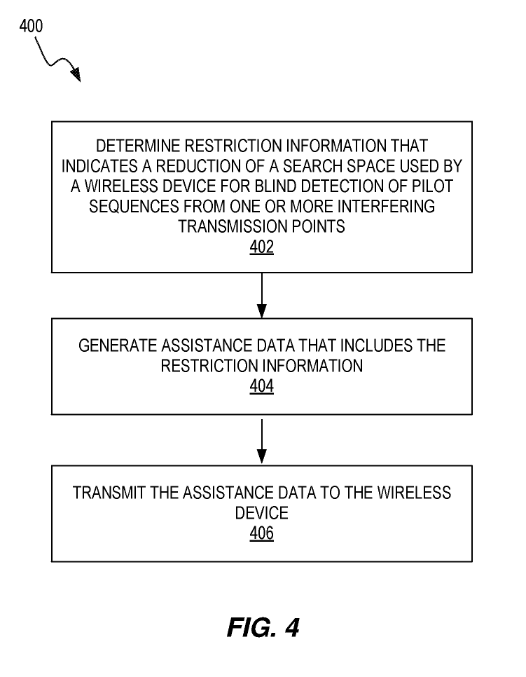

The restriction control circuit 52, as part of the processing circuit 14, is configured to perform operations illustrated by example method 400 of FIG. 4. For example, the restriction control circuit 52 is configured to determine restriction information (block 402 of FIG. 4). In some cases, restriction information is identified from one or more pilot sequence parameters used by interfering transmission points to restrict which pilot sequences are used. In other cases, the network node 10 selects or generates the restriction information.

The restriction control circuit 52 is also configured to generate the assistance data 80 that includes the restriction information (block 404). The assistance data 80 is not limited to the restriction information and can contain other information to assist the wireless device 12 in communication and interference mitigation. The restriction information may be coded or embedded in the assistance data 80.

The restriction control circuit 52 is also configured to send or transmit the assistance data 80 to a wireless device 12 (block 406). This may be done using a wireless communication interface 18. The assistance data 80 includes the restriction information that indicates a reduction of a search space used by the wireless device 12 for blind detection of pilot sequences from interfering transmission points.

In a further example, the restriction information comprises DMRS identifier information to be used by the wireless device 12 to determine a DMRS sequence. The restriction control circuit 52 is configured to determine restriction information to place restrictions on the DMRS sequences used by one or more interfering transmission points and searched by the wireless device 12. In some embodiments, the restriction control circuit 52 is configured to obtain DMRS sequence information of other transmission points that are interfering transmission points with respect to serving the given wireless device 12.

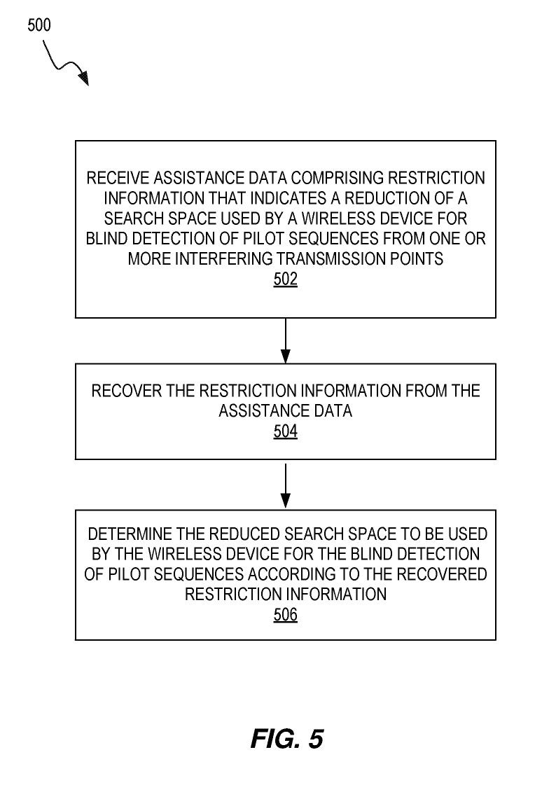

Correspondingly, the wireless device 12 includes a blind detection circuit 62 and, depending on its intended use and feature set, additional circuitry 64, such as application-level processors, user interface circuitry, etc. The blind detection circuit 62, as part of the processing circuit 36, is configured to perform operations illustrated by example method 500 of FIG. 5. The blind detection circuit 62 is configured to receive the assistance data 80 from the wireless device (block 502 of FIG. 5). The assistance data 80 includes restriction information that indicates a reduction of a search space used by the wireless device 12 for blind detection of pilot sequences from one or more interfering transmission points.

The blind detection circuit 62 is also configured to recover the restriction information from the assistance data 80 (block 504). This may involve parsing or otherwise processing the assistance data 80 to recover the restriction information. Restriction information may be processed from downlink signaling from the network 70 that conveys the assistance data 80. In some cases, the recovered restriction information identifies the manner or extent to which one or more DMRS sequences are or will be restricted. For example, the assistance data 80 may indicate DMRS sequence restriction for one or more interfering transmission points.

The blind detection circuit 62 is configured to determine the reduced search space to be used by the wireless device 12 for the blind detection of pilot sequences (block 506). This reduction is determined according to the recovered restriction information. In turn, the blind detection circuit 62 advantageously configures its blind detection processing such that the effective search space is reduced. For example, the blind detection circuit 62 performs DMRS blind detection for DMRS sequences in a search space that is reduced in size or amount, as compared to an unrestricted search space in the absence of restriction information indicating whether and how the DMRS sequences to be detected are restricted. In some cases, the search space for detecting restricted DMRS sequences is reduced as compared to a maximum or nominal size search space used for full blind detection.

In some embodiments, the blind detection circuit 62 determines one or more DMRS sequences based on the DMRS identifier information. The blind detection circuit 62 then determines one or more channels used by interfering transmission points based on the determined DMRS sequences.

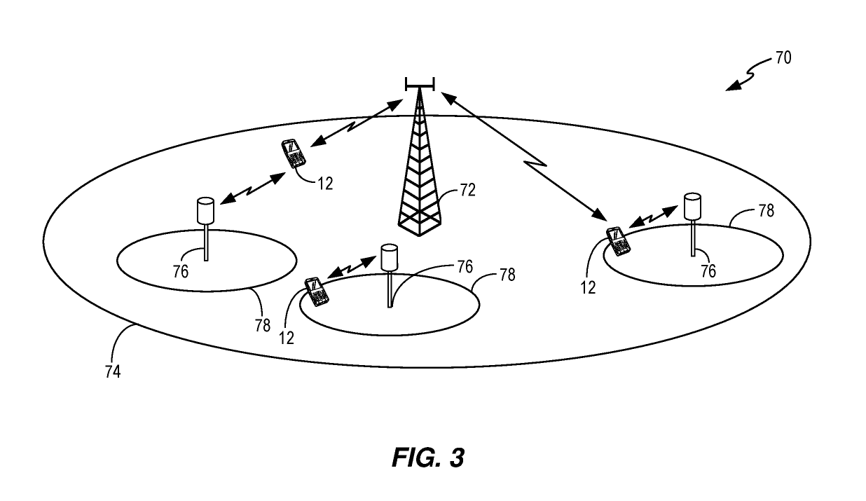

FIG. 3 illustrates a non-limiting example of a network 70 in which the embodiments described herein may be applied. The network depiction is partial, e.g., a portion of a Radio Access Network or RAN is shown and Core Network details are not provided. For an LTE example, the RAN is an E-UTRAN and the Core Network would be an Evolved Packet Core or EPC.

As a further non-limiting aspect, the network 70 is configured in a heterogeneous arrangement with a macro base station 72 that provides coverage in a macro cell 74. A number of micro or pico base stations 76 operate as low power nodes in comparison to the macro base station 72 and provide limited coverage in corresponding micro cells 78. The micro cells 78 may extend the coverage area of the macro cell 74, fill in coverage gaps within the macro cell 78 and/or provide hotspot coverage in high-use areas. The hotspots may provide increased capacity and/or higher data rates.

With the above in mind, The network node 10 may be a base station or other radio network node in such a heterogeneous radio access network, e.g., it may be a macro layer base station 72 in communication with one or more pico or micro layer base stations 76 providing hotspot or overlaid radio service 78 within a macro cell 74 served by the macro cell base station 72. Further, the network node 10 may be a radio network node that controls or coordinates multi-point transmissions, e.g., as used in a distributed antenna system where a given cell includes more than one transmission points.

In another example, the network node 10 implements a method of facilitating DMRS sequence detection by a wireless device 12 operating in a network 70. The method includes determining that a wireless device 12 should be provided with assistance data 80. The method further includes configuring or identifying one or more restrictions that are or will be imposed at one or more transmission points that are considered to be interfering transmission points 72, 76 with respect to the wireless device 12. The method includes generating the assistance data 80 that includes restriction information indicating the one or more restrictions and transmitting the assistance data 80 to the wireless device 12. This indicates to the wireless device 12 one or more reductions applicable to a search space used by the wireless device 12 for blind detection of DMRS sequences with respect to the one or more interfering transmission points 72, 76.

In a corresponding example, the wireless device 12 implements a method of facilitating its DMRS sequence detection operations based on received assistance data 80 from a network 70. The assistance data 80 includes restriction information indicating one or more restrictions imposed on DMRS sequences transmitted by one or more interfering transmission points 72, 76 in the network 70. The method also includes parsing or otherwise processing the assistance data 80 to recover the restriction information. The method further includes determining a reduced search space to be used by the wireless device 12 for blind detection of the DMRS sequences transmitted by the interfering transmission points 72, 76. The method further includes performing blind detection with respect to the DMRS sequences transmitted by the one or more interfering transmission points 72, 76, according to a reduced search space. The reduced search space is reduced in one or more dimensions or aspects as compared to a maximum or nominal sized search space used for blind detection of DMRS sequences in the absence of any assistance data 80.

While not explicitly shown, it will be appreciated that there may be sidehaul or backhaul communication links between the base stations 72 and 76, and it will be appreciated that any one or more of the wireless devices 12 depicted in FIG. 3 may be configured according to the device-side teachings given herein.

Examples of restriction parameters included in restriction information signaled by the network 70 include any one or more of the items described below. Note that although terminology from 3GPP LTE has been used in this disclosure to exemplify the teachings herein, this should not be seen as limiting the scope of the teachings to only the aforementioned system. Other wireless systems, including WCDMA, WiMax, UMB and GSM, may also benefit from exploiting the ideas covered within this disclosure.

Also, note that UE will continue to be used in the examples below to represent wireless device 12 for ease of explanation and should be considering non-limiting. Examples herein also focus on wireless transmissions in the downlink, but the teachings are equally applicable in the uplink.

However, further information for DMRS sequences will better inform these examples and is provided here. Data transmission based on transmission modes 8, 9 and 10 in LTE uses a DMRS as a pilot/reference signal. DMRS is based on a pseudo-random sequence generated by a pseudo-random sequence generator that is initialized with

cᵢₙᵢₜ=(└nₛ/2┘+1)·(2n_{ID}⁽ⁿ^{_{SCID}}⁾+1)·n_{SCID}

at the start of each subframe. The quantities n_{ID}⁽ⁱ⁾, i=0, 1 are given by n_{ID}⁽ⁱ⁾=N_{ID}^{cell} if no value for n_{ID}^{DMRS,i} is provided by higher layers or if downlink control or DCI format 1A, 2B or 2C is used for the DCI associated with the PDSCH transmission. Otherwise, n_{ID}⁽ⁱ⁾=n_{ID}^{DMRS,i}.

As seen above, DMRS sequences depend on slot number n, and the parameters n_{ID}⁽ⁱ⁾ and n_{SCID} or scrambling code ID. The value of n_{SCID} used for a PDSCH can be signaled to the UE receiving the PDSCH by DL control information for each subframe.

The parameter n_{ID}⁽ⁱ⁾ is, for transmission mode 8 and 9, equal to the cell-id, N_{ID}^{cell}. The same cell-id value is used in many places in the LTE specifications and can in a sense be viewed as defining a logical cell. For transmission mode 10, configurability with respect to n_{ID}⁽ⁱ⁾ was introduced and n_{ID}⁽ⁱ⁾=n_{ID}^{DMRS,i}, where there are two parameters n_{ID}^{DMRS,i}, i=0, 1 configured by higher layers. One refers to n_{ID}^{DMRS,i} as a configurable cell-id (CCID) since it plays a similar role as a “true” cell-id N_{ID}^{cell} in the formula. The parameter n_{SCID} is for transmission mode 10 used to select between one of the two CCIDs (in addition to affecting the least significant bit of cᵢₙᵢₜ). For this reason, one generally refers to n_{SCID} as a CCID selector. The parameter n_{ID}⁽ⁱ⁾ is equal to the selected CCID and is thus in a sense also configurable. This provides motivation for also calling n_{ID}⁽ⁱ⁾ a CCID. Henceforth, the term CCID can thus refer to n_{ID}^{DMRS,i} and/or n_{ID}⁽ⁱ⁾. If there is a need for distinction, the parameter n_{ID}⁽ⁱ⁾ will be referred to as selected CCID. The terms CCID, CCID selector and selected CCID all have a direct mapping to the mentioned parameters.

The UE can obtain N_{ID}^{cell} by detecting and estimating other cells' PSS/SSS, and CRS. The value n_{ID}^{DMRS,i} can take one out of 504 values. The slot number can easily be estimated from timing information of the other cells, e.g. using PSS/SSS, or CRS. Here, PSS denotes Primary Synchronization Signal, and SSS denotes Secondary Synchronization Signal.

For current UEs to blindly detect n_{SCID} for interfering signals, the UE needs to be able to decode other UEs' downlink (DL) control channels. Such decoding demands a lot of computations and a good signal-to-noise ratio or SNR. The UE also needs to know (or estimate) the user ids of other UEs. Trying all different values of n_{ID} will demand a lot of computational power and there is a high risk of choosing the wrong n_{ID} value by chance. In general, the values of the above DMRS parameters can be chosen freely by the network and vary from subframe to subframe or by the rate of higher layer signaling. In total, the UE has to try 504*2+1 different DMRS sequences to find the correct sequence in one subframe and for one scheduled user which would put a huge burden on the implementation.

Continuing with the examples to reduce the search space and overcome such issues, DMRS identifier information may include DMRS sequence information. Possible DMRS sequence information signaling can be any combination of the following:
The exact value of n_{SCID} for all transmission from a specific transmission point;
n_{SCID} is the same as the UE own n_{SCID};
n_{ID}^{DMRS,i} only takes the values from the list CSI virtual cell id list;
n_{ID} is always equal to N_{ID}^{cell}; and
n_{ID}^{DMRS,i} has the first x bit constant and n-x bit can vary. The first x bit is also signaled. n is the length of number of bits used for representing n_{ID}^{DMRS,i}.

DMRS initialization parameters are explicitly signaled in some embodiments. For example, the restriction information includes DMRS identifier information to be used by the wireless device to determine a DMRS sequence. DMRS identifier information includes CCIDs, SCIDs, N_{ID}s or any other DMRS related identifiers used to reduce the search space for blind detection operations of the UE. The network node 10 may signal explicit candidate DMRS initialization parameters to a UE. The UE may use the candidate parameters for assisting in finding DMRS sequences that correspond to relevant interferers.

In some embodiments, the restriction information comprises CCID information that restricts a number of CCIDs to be considered by the UE in its blind detection operations. Examples of signaled DMRS parameters include CCIDs. For example, CCID information may include one or more DMRS CCIDs. CCID information may also include an M bit subset of the N bits of a CCID and the remaining N−M bits generate DMRS sequence candidates.

The restriction information identifies one or more CCID selectors used by ones of the one or more interfering transmission points 72, 76, in some embodiments. The signaling of a CCID selector could be compressed by saying that the same CCID selector value should be assumed for all, or at least a significant subset of, DMRS sequences. The so called “common” CCID selector value could in addition be signaled. The mentioned subset could, for example, involve all DMRS sequences within a certain set of CCID values. The set could also contain just a single CCID value.

The restriction information may restrict CCIDs to be searched by the UE to one or more CCIDs associated with at least one of a channel state information reference signal, CSI-RS, configuration, a CSI-RS resource, a common reference signal, CRS, a primary synchronization signal, PSS, and a secondary synchronization signal, SSS, at the UE.

As previously indicated, CRS are not the only reference symbols available in LTE. As of LTE Release-10, a new RS concept was introduced with separate UE specific RS for demodulation of PDSCH and RS for measuring the channel for the purpose of CSI feedback from the UE. The latter is referred to as CSI-RS. CSI-RS are not transmitted in every subframe and they are generally sparser in time and frequency than RS used for demodulation. CSI-RS transmissions may occur every 5th, 10th, 20th, 40th, or 80th subframe according to an RRC configured periodicity parameter and an RRC configured subframe offset.

DMRS CCID association to CCID for a CSI-RS configuration/resource is another example of restriction information. The network 70 signals to the UE an association between a DMRS CCID and CCID for a CSI-RS configuration/resource. Naturally, the signaling could correspond to multiple such associations. The signaling includes one or more of, or combinations thereof:
Signaling that a DMRS CCID can be assumed to be the same as CCID of a CSI-RS configuration/resource the UE is configured with or will/can be configured with (this creates an association between a DMRS CCID and a CSI-RS configuration);
Including signaling that all CCIDs of all configured CSI-RS configurations for the UE can be included in the UE's candidate set of DMRS CCID;
Signaling that a DMRS CCID can be assumed to be the same as CCID of a certain CSI-RS configuration/resource the UE is configured with or will/can be configured with (this creates an association between a DMRS CCID and a certain CSI-RS configuration);
Explicitly signaling a DMRS CCID and the association to a certain CSI-RS configuration;
Including signaling for each of the CSI-RS configurations the UE is configured with or will/can be configured with;
Signaling that DMRS CCIDs (n_{ID}^{DMRS,i}) only take their values from a CSI-RS CCID list/set; and
CCID list/set may be network configurable and conveyed to UE in a signaling message.

The signaling may indicate a UE assumption that the DMRS and its associated CSI-RS configuration are quasi-co-located (QCL) with respect to channel strength/received signal strength. Alternatively, the UE makes this assumption on its own. The UE may use measurements on CSI-RS configurations to infer whether corresponding associated DMRS CCID(s) are relevant candidates used by interfering signals.

Signaling for multiple CSI-RS configurations/resources can be supported by repeating the above but for a different CSI-RS resource either in the same signaling message or using multiple separate signaling messages.

Restriction information may also involve DMRS CCID association to a cell-id. For example, the network 70 signals that a DMRS is associated to a cell-id for a CRS, PSS, SSS or a combination thereof. The signaling includes one or more of, or combinations thereof:
Signaling that a DMRS CCID can be assumed to be the same as a cell-id;
Signaling that a DMRS CCID can be assumed to be the same as a cell-id where the cell-id value is part of the signaling—This includes signaling a set of DMRS CCIDs that are associated to a cell id;
Signaling that DMRS CCID (or n_{ID}) is always equal to a cell-id (or N_{ID}^{cell}); and
Signaling that DMRS CCID(s) are setup in the same way as in transmission mode 8 and/or 9, or alternatively signaling that leads to the same CCID setup as if transmission mode 8 and/or 9 was used (i.e., equivalent signaling).

The signaling may indicate that the UE assumes that the DMRS and references signals related to the associated cell-id (including e.g. PSS/SSS, and/or CRS) are QCL with respect to channel strength/received signal strength. Alternatively, the UE makes this assumption on its own. The UE may use measurements on references signals related to the associated cell-id to infer whether a corresponding associated DMRS CCID is a relevant candidate for interfering signals.

Signaling for multiple cell-ids can be supported by repeating the above but for a different cell-id, either in the same signaling message or using multiple separate signaling messages.

Restriction information may include information related to CCID selectors. The network signals DMRS CCID selector information to the UE. The signaling includes one or more of, or combinations thereof:
The exact value of CCID selector or n_{SCID} for all transmissions using a specific DMRS CCID. Note that the specific DMRS CCIDs can correspond to a cell-id. The specific DMRS CCID often corresponds to all transmissions from a specific transmission point; and
An indication that the CCID selector or n_{SCID} is the same as the UE's own CCID selector or n_{SCID}.

In some cases, the network 70 signals DMRS CCID information to the UE. The signaling includes one or more of, and combinations thereof:
Signal that n_{ID}^{DMRS,i} only takes the values from a CSI-RS CCID list/set; and
CCID list/set may be network configurable and conveyed to UE in a signaling message.

Time coherence of DMRS sequence parameters may be included in restriction information, according to some embodiments. The network may signal to a UE information concerning how DMRS sequence parameters for interfering signals may be assumed to change/evolve over time/frequency. Although time is discussed for purposed of explanation, these examples are also applicable to the other dimension of frequency, or combinations thereof. The network may signal to the UE one or more of, or combinations thereof:
Signaling that a UE may assume the DMRS candidate set does not change;
Including until further notice;
Including signaling size of candidate set;
Incusing maximum size of candidate set;
Minimum size of candidate set;
Including signaling from what point in time the candidate set may be assumed to not change (may be implicit via the timing of the reception of the signaling message);
Signaling DMRS sequence information that a UE may assume for a set of subframes;
Set of subframes (subframe pattern) could be specified with a bitmap;
Set of subframes (subframe pattern) could be periodic;
Set of subframes could be relative a reference subframe and reference subframe could evolve over time; and
Including the case when the set of subframes involve the next M subframes into the future.

In some cases, a DMRS candidate set includes only partially knowing the DMRS sequence. So a DMRS candidate set could, for example, here mean only DMRS CCID, or only DMRS CCID selector, or both. The term can therefore be interpreted to include all different DMRS sequence related parameters (and combinations thereof) mentioned elsewhere in this disclosure. Similarly, the term DMRS identifier information may include DMRS sequence information. For example, DMRS sequence information could refer, for example, to DMRS CCID only, DMRS CCID selector only, or selected DMRS CCID, or any combination thereof. The above time coherence signaling can be combined with any of the other mentioned exemplary embodiments in this disclosure.

DMRS sequence information for subframe sets may be particularly useful in heterogeneous deployments where the dominating interferers may change from subframe to subframe in a predictable fashion if the macro layer decides to blank resources in a predictable fashion. Informing a UE that a DMRS candidate set does not change allows the UE to use observations from many subframes to narrow down the DMRS candidate set on its own, or to further narrow it down in combination with additional DMRS sequence information.

DMRS information can be signaled over the backhaul. The DMRS sequence information sequence corresponds to a signaling which in general is intended between the eNodeB and the UE. However the same or related information may need to be exchanged also between different nodes. The inter-node signaling could be performed on a standardized protocol such as X2 or in a proprietary manner. Nevertheless, it is clear that if a UE receives signaling from the network involving information about the DM-RS sequences used by other nodes, a related information exchange occurs between the node(s) that are sending the information to the UE and those other nodes, unless the signaling is transmitted directly over the air from each node relevant from an interference perspective for the UE of interest

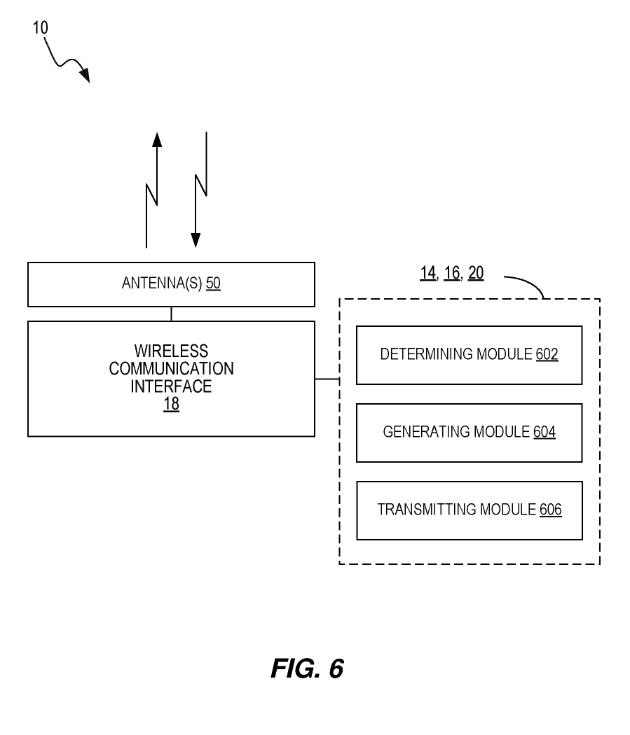

FIG. 6 illustrates an example functional module or circuit architecture as may be implemented in a network node 10, such as in a base station 72, 76 or an eNodeB of an LTE network, based on the processing circuit 14 executing computer program instructions included in the computer program 20 stored in the storage memory 16. The illustrated embodiment includes a determining module 602 configured to determine restriction information that indicates a reduction of a search space used by the wireless device 12 for blind detection of pilot sequences from one or more interfering transmission points 72, 76. The embodiment also includes a generating module 604 configured to generate assistance data 80 that includes the restriction information and a transmitting module 606 configured to transmit the assistance data 80 to the wireless device 12.

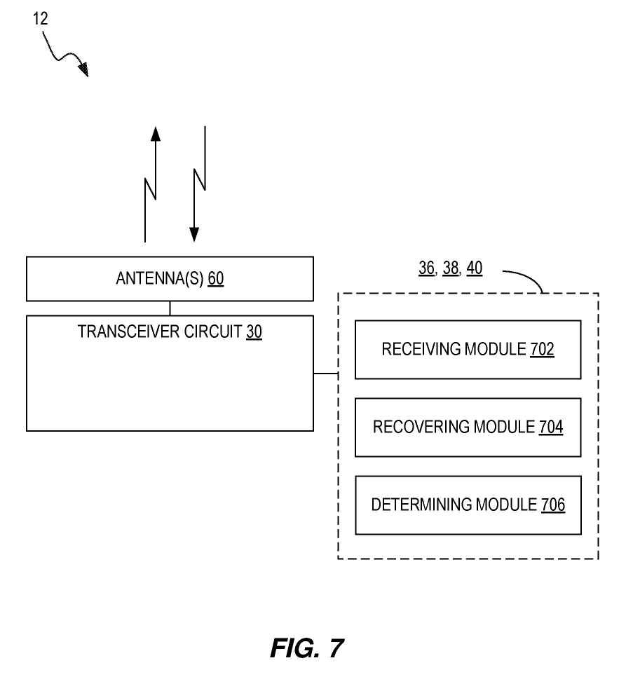

FIG. 7 illustrates an example functional module or circuit architecture as may be implemented in a wireless device 12, such as a UE in an LTE network, based on the processing circuit 36 executing computer program instructions included in the computer program 40 stored in the storage memory 38. The illustrated embodiment includes a receiving module 602 configured to receive assistance data 80 comprising restriction information that indicates a reduction of a search space used by the wireless device 12 for blind detection of pilot sequences from one or more interfering transmission points 72, 76. The embodiment also includes a recovering module 604 configured to recover the restriction information from the assistance data 80 and a determining module 606 configured to determine the reduced search space to be used by the wireless device 12 for the blind detection of pilot sequences according to the recovered restriction information.

One aspect of the teachings herein addresses the problem of a UE blindly detecting and estimating a pilot sequence, e.g., a DMRS sequence based on the network signaling one or more restrictions for the possible DMRS sequences. Such pilot estimation is of great importance in interference mitigation.

According to some embodiments, the teachings herein limit or reduce the search space considered by a UE in blindly detecting the DMRS sequences transmitted by other interfering transmission points. The search space limitations are defined by network-signaled restriction information, e.g., restriction parameters or combinations of parameters, which may be selected by the network to tailor the restriction. In the various examples, “UE” denotes a wireless device 12, apparatus or system that is configured to operate in a given network 70. For example, the term UE may denote a cellular device such as a smartphone, tablet, computer, etc., but the term is not limited to those examples.

In one approach, the network 70 selects or generates a restriction to be imposed on DMRS sequence generation. The restrictions are imposed on at least a subset of cells comprising the network, and the nature and/or extent of the restriction may be intelligently determined by the network in dependence on, for example, the presence of UEs capable of interference mitigation and/or on the scheduling freedom needed by the network to provide active or requested communication services.

Among other things, the teachings herein reduce the computational demands on a UE that intends to use interference mitigation of other cells. It also reduces the risk of blindly detecting the wrong reference signal sequence and hence improves interference mitigation over UEs that have to perform completely blind detection of the pilot sequence—i.e., over the entire search space universe.

Some embodiments include a non-transitory computer readable storage medium storing a computer program comprising program instructions that, when executed on at least one processing circuit (14) of a network node (10), configure the network node (10) to facilitate pilot sequence detection by a wireless device (12) operating in a wireless communication network (70), based on causing the at least one processing circuit (14) to perform operations to control the network node (10) to: determine (402) restriction information that indicates a reduction of a search space used by the wireless device (12) for blind detection of pilot sequences from one or more interfering transmission points (72, 76); generate (404) assistance data (80) that includes the restriction information; and transmit (406) the assistance data (80) to the wireless device (12).

Some embodiments include a non-transitory computer readable storage medium storing a computer program comprising program instructions that, when executed on at least one processing circuit (36) of a wireless device (12), configure the wireless device (12) to facilitate pilot sequence detection for operating in a wireless communication network (70), based on causing the at least one processing circuit (36) to perform operations to control the wireless device (12) to: receive (502) assistance data (80) comprising restriction information that indicates a reduction of a search space used by the wireless device (12) for blind detection of pilot sequences from one or more interfering transmission points (72, 76); recover (504) the restriction information from the assistance data (80); and determine (506) the reduced search space to be used by the wireless device (12) for the blind detection of pilot sequences according to the recovered restriction information.

Some embodiments include a network node (10) configured to facilitate pilot sequence detection by a wireless device (12) operating in a wireless communication network (70), comprising: a determining module (602) configured to determine restriction information that indicates a reduction of a search space used by the wireless device (12) for blind detection of pilot sequences from one or more interfering transmission points (72, 76); a generating module (604) configured to generate assistance data (80) that includes the restriction information; and a transmitting module (606) configured to transmit the assistance data (80) to the wireless device (12).

Some embodiments include a wireless device (12) configured to facilitate pilot sequence detection for operating in a wireless communication network (70), comprising: a receiving module (602) configured to receive assistance data (80) comprising restriction information that indicates a reduction of a search space used by the wireless device (12) for blind detection of pilot sequences from one or more interfering transmission points (72, 76); a recovering module (604) configured to recover the restriction information from the assistance data (80); and a determining module (606) configured to determine the reduced search space to be used by the wireless device (12) for the blind detection of pilot sequences according to the recovered restriction information.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-24. (canceled)

25. A method, by a network node, of facilitating pilot sequence detection by a wireless device operating in a wireless communication network, comprising:
determining restriction information that indicates a reduction of a search space used by the wireless device for blind detection of pilot sequences from one or more interfering transmission points;
generating assistance data that includes the restriction information; and
transmitting the assistance data to the wireless device.

26. The method of claim 25, wherein the restriction information comprises demodulation reference signal, DMRS, identifier information to be used by the wireless device to determine a DMRS sequence.

27. The method of claim 25, wherein the restriction information comprises configurable cell ID, CCID, information that restricts a number of CCIDs to be considered by the wireless device in its blind detection operations.

28. The method of claim 25, wherein the restriction information comprises scrambling code ID, SCID, information pertaining to a DMRS sequence transmitted from ones of the one or more interfering transmission points.

29. The method of claim 25, wherein the restriction information restricts CCIDs to be searched by the wireless device to one or more CCIDs associated with at least one of a channel state information reference signal, CSI-RS, configuration, a CSI-RS resource, a common reference signal, CRS, a primary synchronization signal, PSS, and a secondary synchronization signal, SSS, at the wireless device.

30. The method of claim 25, wherein the restriction information identifies one or more CCID selectors used by ones of the one or more interfering transmission points.

31. The method of claim 25, wherein determining restriction information comprises identifying the restriction information from one or more pilot sequence parameters used by ones of the one or more interfering transmission points to restrict which pilot sequences are used by the one or more interfering transmission points.

32. A method, by a wireless device, of facilitating pilot sequence detection for operating in a wireless communication network, comprising:
receiving assistance data comprising restriction information that indicates a reduction of a search space used by the wireless device for blind detection of pilot sequences from one or more interfering transmission points;
recovering the restriction information from the assistance data; and
determining the reduced search space to be used by the wireless device for the blind detection of pilot sequences according to the recovered restriction information.

33. The method of claim 32, further comprising performing the blind detection of pilot sequences within the reduced search space.

34. The method of claim 32, wherein the restriction information comprises demodulation reference signal, DMRS, identifier information, and wherein the method further comprises determining one or more DMRS sequences based on the DMRS identifier information.

35. The method of claim 32, further comprising determining one or more channels used by ones of the one or more interfering transmission points based on the one or more DMRS sequences.

36. A network node configured to facilitate pilot sequence detection by a wireless device operating in a wireless communication network, comprising:
a processing circuit configured to:
determine restriction information that indicates a reduction of a search space used by the wireless device for blind detection of pilot sequences from one or more interfering transmission points;
generate assistance data that includes the restriction information; and
transmit the assistance data to the wireless device.

37. The network node of claim 36, wherein the restriction information comprises demodulation reference signal, DMRS, identifier information to be used by the wireless device to determine a DMRS sequence.

38. The network node of claim 36, wherein the restriction information comprises configurable cell ID, CCID, information that restricts a number of CCIDs to be considered by the wireless device in its blind detection operations.

39. The network node of claim 36, wherein the restriction information comprises scrambling code ID, SCID, information pertaining to a DMRS sequence transmitted from ones of the one or more interfering transmission points.

40. The network node of claim 36, wherein the restriction information restricts CCIDs to be searched by the wireless device to one or more CCIDs associated with at least one of a channel state information reference signal, CSI-RS, configuration, a CSI-RS resource, a common reference signal, CRS, a primary synchronization signal, PSS, and a secondary synchronization signal, SSS, at the wireless device.

41. The network node of claim 36, wherein the restriction information identifies one or more CCID selectors used by ones of the one or more interfering transmission points.

42. The network node of claim 36, wherein the processing circuit is configured to determine restriction information by identifying the restriction information from one or more pilot sequence parameters used by ones of the one or more interfering transmission points to restrict which pilot sequences are used by the one or more interfering transmission points.

43. A wireless device configured to facilitate pilot sequence detection for operating in a wireless communication network, comprising:
a transceiver configured to transmit and receive wireless signals; and
a processing circuit operatively connected to the transceiver and configured to:
receive assistance data comprising restriction information that indicates a reduction of a search space used by the wireless device for blind detection of pilot sequences from one or more interfering transmission points;
recover the restriction information from the assistance data; and
determine the reduced search space to be used by the wireless device for the blind detection of pilot sequences according to the recovered restriction information.

44. The wireless device of claim 43, wherein the processing circuit is configured to perform the blind detection of pilot sequences within the reduced search space.

45. The wireless device of claim 43, wherein the restriction information comprises demodulation reference signal, DMRS, identifier information, and wherein the processing circuit is configured to determine one or more DMRS sequences based on the DMRS identifier information.

46. The wireless device of claim 43, wherein the processing circuit is configured to determine one or more channels used by ones of the one or more interfering transmission points based on the one or more DMRS sequences.

47. A non-transitory computer readable storage medium storing a computer program comprising program instructions that, when executed on at least one processing circuit of a network node in a wireless communication network, configure the network node to facilitate pilot sequence detection by a wireless device operating in the network, based on causing the at least one processing circuit to perform operations to control the network node to:
determine restriction information that indicates a reduction of a search space used by the wireless device for blind detection of pilot sequences from one or more interfering transmission points;
generate assistance data that includes the restriction information; and
transmit the assistance data to the wireless device.

48. A non-transitory computer readable storage medium storing a computer program comprising program instructions that, when executed on at least one processing circuit of a wireless device, configure the wireless device to facilitate pilot sequence detection for operating in a wireless communication network, based on causing the at least one processing circuit to perform operations to control the wireless device to:
receive assistance data comprising restriction information that indicates a reduction of a search space used by the wireless device for blind detection of pilot sequences from one or more interfering transmission points;
recover the restriction information from the assistance data; and
determine the reduced search space to be used by the wireless device for the blind detection of pilot sequences according to the recovered restriction information.
